(19) United States
(12) Patent Application Publication
(10) Pub. No.: US 2024/0220926 A1
(43) Pub. Date: Jul. 4, 2024

(54) TECHNIQUES FOR TRAINING A NEURAL NETWORK TO DYNAMICALLY PREDICT ORDER FULFILLMENT

(71) Applicant: PROJECT44, LLC, Chicago, IL (US)

(72) Inventors: William Ewing Blake, Chicago, IL (US); Nicholas Jay Douglas, Wayne, PA (US); Alexander Lukasik, Oak Lawn, IL (US); Andrew Michael Simmons, Oak Park, IL (US)

(21) Appl. No.: 18/604,454

(22) Filed: Mar. 13, 2024

Related U.S. Application Data
(63) Continuation of application No. 17/568,529, filed on Jan. 4, 2022, now abandoned.

(51) Int. Cl. G06Q 10/087; G06N 20/00; G06Q 10/08; G06Q 10/083; G06Q 50/40

(52) U.S. Cl. CPC G06Q 10/087; G06N 20/00; G06Q 10/08; G06Q 10/083; G06Q 50/40

(57) ABSTRACT

Systems and methods for training and using deep learning artificial neural networks are provided. According to certain aspects, a deep learning artificial neural network is initially trained using a training dataset, and is used to analyze shipping data and order data associated with a shipping agreement and output a probability that the shipping agreement will be successfully fulfilled. The deep learning artificial neural network is updated with information indicating the order data associated with the shipping agreement and the probability that the shipping agreement will be successfully fulfilled.

### CROSS-REFERENCE TO RELATED APPLICATIONS

This application is a continuation of U.S. patent application Ser. No. 17/568,529, filed Jan. 4, 2022. The disclosure of this application is hereby incorporated by reference in its entirety.

### FIELD

The present disclosure is directed to training machine learning models. More particularly, the present disclosure is directed to platforms and technologies for training and using a neural network to dynamically predict order fulfillment.

### BACKGROUND

The transportation and logistics industry is made up of various entities that contract or agree to handle the transportation of physical items between and among locations. In particular, the transportation and logistics industry generally includes shippers (i.e., entities having physical items to transport) and carriers (i.e., entities having transport equipment to transport the physical items). There are additional entities known as third-party logistics (3PL) entities that receive quote requests from shippers, determine rates offered by the carriers to accommodate the requests, and ultimately broker shipping agreements between a shipper and a carrier. Communication among the shippers, 3PL entities, and carriers may be facilitated using Transportation Management Systems (TMS).

Currently, when a shipping agreement is brokered or reached between a shipper and a carrier, the shipper may assume that the carrier is going to successfully complete the shipping agreement, but in reality certain factors may disrupt or affect the shipment. For example, not all of the products specified by a shipping agreement may be loaded onto the allocated vehicles. Therefore, the likelihood of the shipping agreement actually being successfully fulfilled is in flux. As a result, the shipper does not have visibility into whether the shipment will be successfully fulfilled which may disrupt operations.

Accordingly, there is an opportunity for platforms and technologies to leverage data sources and data analyses techniques to effectively and accurately determine whether a product shipment specified in a shipping agreement will be successfully fulfilled.

### SUMMARY

In an embodiment, a computer-implemented method of training and using deep learning artificial neural networks is provided. The method may include: training, by one or more computer processors, a deep learning artificial neural network using a training dataset comprising: (i) a training set of order milestones, (ii) a training set of shipment statuses, and (iii) a training set of differences between planned shipment amounts and actual shipment amounts; storing the deep learning artificial neural network in a memory; receiving shipping data associated with a set of vehicles transporting products associated with a shipping agreement; on a continuous basis as the shipping data is received, analyzing, by the one or more computer processors using the deep learning artificial neural network that was trained, the shipping data and order data associated with the shipping agreement, the order data indicating (i) whether the shipping agreement is divided into partial shipments, and (ii) an amount of products planned to be transported, and the shipping data indicating an amount of products actually being transported; based on the analyzing, outputting, by the deep learning artificial neural network, a probability that the shipping agreement will be successfully fulfilled, wherein the probability is less than a threshold percentage; and updating, by the one or more computer processors, the deep learning artificial neural network with information indicating the order data associated with the shipping agreement and the probability that the shipping agreement will be successfully fulfilled.

In another embodiment, a system for training and using deep learning artificial neural networks is provided. The system may include: a memory storing a set of computer-readable instructions and data associated with a deep learning artificial neural network; and one or more processors interfaced with the memory, and configured to execute the set of computer-readable instructions to cause the one or more processors to: train a deep learning artificial neural network using a training dataset comprising: (i) a training set of order milestones, (ii) a training set of shipment statuses, and (iii) a training set of differences between planned shipment amounts and actual shipment amounts, store the deep learning artificial neural network in a memory, receive shipping data associated with a set of vehicles transporting products associated with a shipping agreement, on a continuous basis as the shipping data is received, analyze, using the deep learning artificial neural network that was trained, the shipping data and order data associated with the shipping agreement, the order data indicating (i) whether the shipping agreement is divided into partial shipments, and (ii) an amount of products planned to be transported, and the shipping data indicating an amount of products actually being transported, based on the analyzing, output, by the deep learning artificial neural network, a probability that the shipping agreement will be successfully fulfilled, wherein the probability is less than a threshold percentage, and update the deep learning artificial neural network with information indicating the order data associated with the shipping agreement and the probability that the shipping agreement will be successfully fulfilled.

Further, in an embodiment, a non-transitory computer-readable storage medium configured to store instructions executable by a computer processor is provided. The instructions may include: instructions for training a deep learning artificial neural network using a training dataset comprising: (i) a training set of order milestones, (ii) a training set of shipment statuses, and (iii) a training set of differences between planned shipment amounts and actual shipment amounts; instructions for storing the deep learning artificial neural network in a memory; instructions for receiving shipping data associated with a set of vehicles transporting products associated with a shipping agreement; instructions for, on a continuous basis as the shipping data is received, analyzing, using the deep learning artificial neural network that was trained, the shipping data and order data associated with the shipping agreement, the order data indicating (i) whether the shipping agreement is divided into partial shipments, and (ii) an amount of products planned to be transported, and the shipping data indicating an amount of products actually being transported; instructions for, based on the analyzing, outputting, by the deep learning artificial neural network, a probability that the shipping agreement will be successfully fulfilled, wherein the probability is less than a threshold percentage; and instructions for updating the deep learning artificial neural network with information indicating the order data associated with the shipping agreement and the probability that the shipping agreement will be successfully fulfilled.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2 depicts an exemplary deep learning artificial neural network (DNN) that may be employed by the systems and methods, in accordance with some embodiments.

FIG. 3 depicts an example signal diagram associated with using machine learning to predict order fulfillment, in accordance with some embodiments.

FIG. 4 depicts an example dashboard interface for a shipper entity, in accordance with some embodiments.

FIG. 5 illustrates an example flow diagram of using machine learning to predict order fulfillment, in accordance with some embodiments.

### DETAILED DESCRIPTION

The present embodiments may relate to, inter alia, analyzing various data associated with a particular product shipment using a machine learning model to predict a likelihood that the product shipment will be successfully fulfilled. According to certain aspects, systems and methods may initially train the machine learning model using a set of training data, and store the machine learning model in memory for subsequent use.

Subsequent to a shipping agreement for a set of products being reached between a shipper and a carrier, the systems and methods may interface with a set of data sources and receive various data associated with the shipment of the set of products and conditions related thereto, including order fulfillment milestones, shipment statuses, inventory deviations, and various economic trends. The systems and methods may input the received information into the machine learning model, which may output a probability that the shipping agreement/product order will be successfully fulfilled.

The systems and methods may update a status or information associated with the shipping agreement, and may enable a customer (e.g., the shipper) to access a dashboard or other interface that informs of the status of and other information associated with the shipping agreement. According to certain embodiments, the systems and methods may perform the analyses without use of a machine learning model.

The systems and methods therefore offer numerous benefits. In particular, the systems and methods use machine learning or artificial intelligence techniques to effectively and accurately predict whether a given shipping agreement will be successfully fulfilled, and generate communications indicating the prediction. Thus, the systems and methods enable customers (e.g., shippers) to access and review whether their shipping agreements will be successfully fulfilled, and enable the customers to determine and make adjustments or other actions to account any delays or impacts to additional shipping agreements or general business operations. It should be appreciated that additional benefits are envisioned.

The systems and methods discussed herein address a business challenge, namely a business challenge related to improving how shipper entities assess fulfillment of their shipping agreements. In conventional platforms, a shipping agreement is either successfully or unsuccessfully fulfilled in various degrees, with the shipper entity not having visibility into a success rate during the actual shipment(s). In contrast, the systems and methods are able to ingest or access data from multiple data sources and analyze that data to assess how a shipment associated with the shipping agreement is progressing and predict whether the shipping agreement will be successfully fulfilled, thus enabling the shipping entities to review the information and more effectively and efficiently manage operations.

Therefore, the systems and methods do not merely recite the performance of some business practice known from the pre-Internet world (tracking a shipment) along with the requirement to perform it on the Internet. Instead, the systems and methods incorporate computer networks that enable communications among shipper entities, carrier entities, and data sources such as electronic logging devices, among other entities and components. Thus, the systems and methods are necessarily rooted in computer technology in order to overcome a problem specifically arising in logistics technologies.

According to implementations, the systems and methods may support a dynamic, real-time or near-real-time collection, analysis, and communication of any data that may be associated with conditions related to the shipping agreement. In particular, the systems and methods may dynamically and automatically access or retrieve data indicative of operational conditions such as vehicle locations, analyze the data, and determine shipping conditions and updates. In these ways, the systems and methods discussed herein address technical challenges, namely establishing dynamic data collection, analysis, and communication across dedicated computer systems, including different systems for different carrier entities and shipper entities.

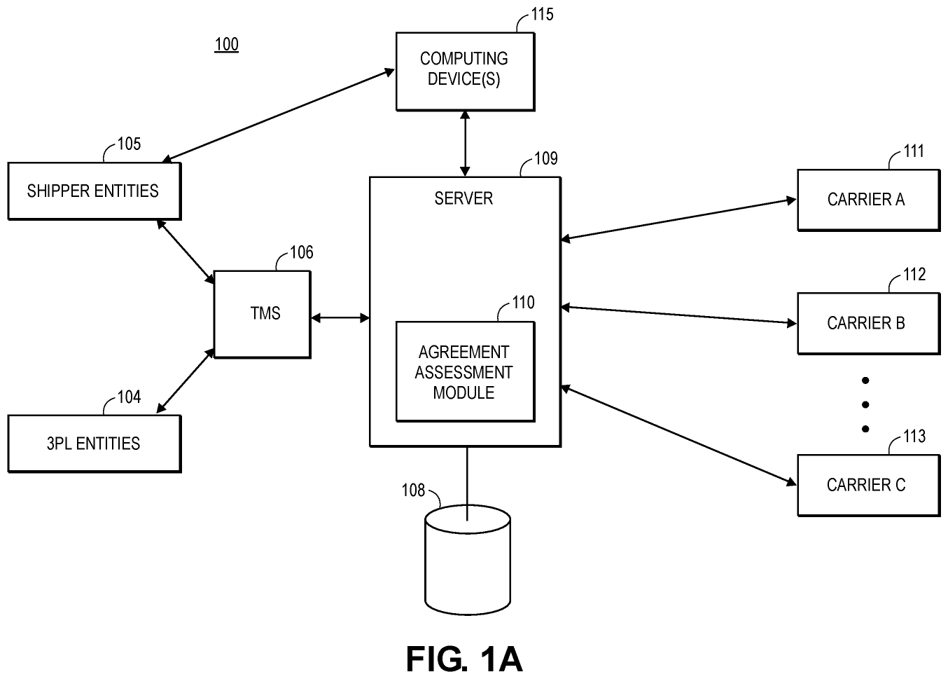

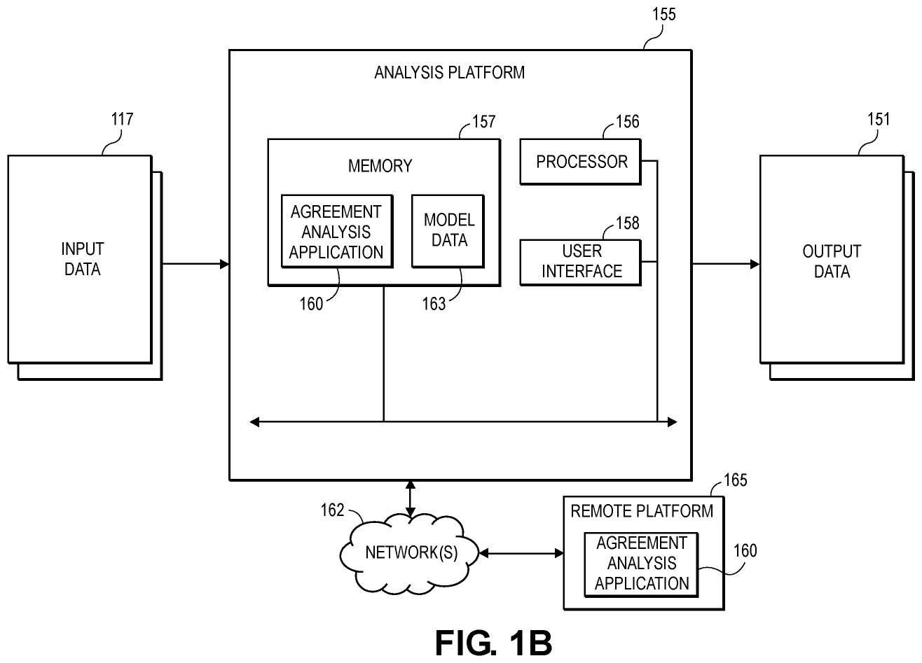

FIG. 1 illustrates an overview of a system 100 of components configured to facilitate the systems and methods. It should be appreciated that the system 100 is merely exemplary and that alternative or additional components are envisioned.

As illustrated in FIG. 1, the system 100 includes a set of shipper entities 105 and a set of 3PL entities 104. Each of the set of shipper entities 105 may be a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 105 may intend to have transported a set of physical goods from an origin location to a destination location, where the set of physical goods may have an associated weight, dimensions, and/or other parameters. It should be appreciated that various amounts of the shipper entities 105 are envisioned.

Each of the 3PL entities 104 may be a third-party provider that the set of shipper entities 105 may use to outsource certain elements associated with handling and managing the transportation of the physical goods. In some embodiments, one or more of the shipper entities 105 may include one or more of the 3PL entities 104 (or vice-versa). The set of 3PL entities 104 may manage the fulfillment of shipping requests that originate from the set of shipper entities 105. Generally, each of the set of 3PL entities 104 may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. Each of the set of 3PL entities 104 may be a single service or may be a system-wide bundle of services capable of managing various aspects of a supply chain (e.g., transportation of physical goods). It should be appreciated that various amounts of the 3PL entities 104 are envisioned.

The system 100 may further include a set of carrier entities (as shown: carrier A 111, carrier B 112, and carrier C 113). Each of the carrier entities 111, 112, 113 may be a company, corporation, business, entity, individual, group of individuals, and/or the like that owns or otherwise has access to a set of vehicles capable of transporting physical goods. According to embodiments, the transportation of goods may be accomplished via marine or water (i.e., using boats or ships), air (i.e., using aircraft), rail (i.e., using trains), or road (i.e., using trucks, cars, or other land-based vehicles). The term “vehicle,” as used herein, may refer to any vessel or craft capable of transporting goods via marine or water, air, rail, and/or road. The shipments of the goods may be categorized differently. Generally, freight shipments may be specific to trucks and may be categorized as less than truckload (LTL) or truckload (TL). Typically, but not always, LTL shipments may range from fifty (50) to 7,000 kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The set of shipper entities 105 and the set of 3PL entities 104 may interface and communicate with a transportation management system (TMS) 106. According to embodiments, the TMS 106 may be any of a general transportation management system, warehouse management system (WMS), order management system (OMS), enterprise resource planning (ERP) system, or otherwise a system that may be used to manage freight. Generally, the TMS 106 may at least partly facilitate shipping agreements between the set of shipper entities 105 and the set of carrier entities 111, 112, 113, where the TMS 106 may facilitate route planning and optimization, load optimization, execution, freight audit and payment, yard management, advanced shipping, order visibility, and carrier management. The TMS 106 may be an open-source system or may be proprietary to any of the set of shipper entities 105 or the set of 3PL entities 104. According to embodiments, the TMS 106 may support specific and particular communication capabilities with the other entities of the system 100. In particular, the TMS 106 may support communication with the other entities via different components and protocols.

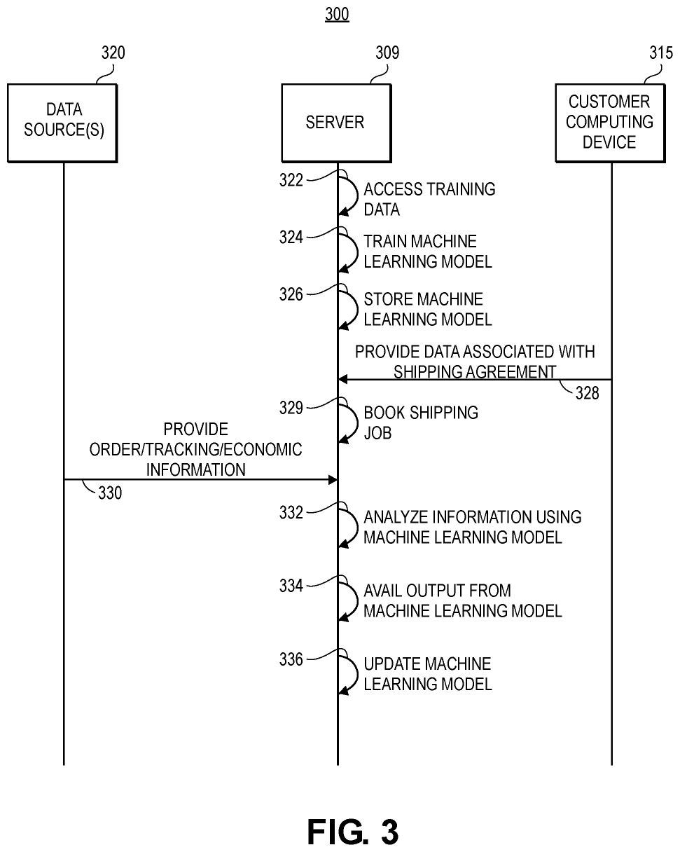

As illustrated in FIG. 1, the system 100 may include a server 109 that may interface and communicate with at least the TMS 106, the set of carrier entities 111, 112, 113, and a set of computing devices 115. The server 109 may include any combination or hardware and software components, and may be associated with any type of entity or individual. The server 109 may support execution of an agreement assessment module 110. According to embodiments, the agreement assessment module 110 may receive various data associated with a shipping agreement and determine, by inputting at least the various data into a machine learning model, a likelihood that the shipping agreement will be successfully fulfilled, as discussed herein with respect to FIGS. 1B and 3. The agreement assessment module 110 may interface with a database 108 or other type of memory configured to store data accessible by the agreement assessment module 110.

The set of computing devices 115 may enable users access to a dashboard, interface, or the like that may include updates to or predicted results of shipping agreements, as determined by the agreement assessment module 110. In embodiments, the set of computing devices 115 may be associated with one or more of the shipper entities 105. Accordingly, the set of computing devices 115 may interface with the server 109 and/or the shipper entities 105.

Although FIG. 1 depicts the server 109 in communication with the TMS 106 and the set of carrier entities 111, 112, 113, it should be appreciated that alternative configurations are envisioned. In one particular implementation, the TMS 106, the 3PL entity 104, and the server 109 may be combined as a single entity (i.e., the server 109 may communicate directly with the shipper entities 105 and the set of carrier entities 111, 112, 113). In another implementation, either the TMS 106 or the 3PL entity 104 may be combined with the server 109 as a single entity capable of performing the respective functionalities.

Although not depicted in FIG. 1, the system 100 may support one or more computer networks that may enable communication between and among the entities and components of the system 100. In embodiments, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 105 and the computing device(s) 115 may communicate with the TMS 106 (and/or with the agreement assessment module 110) via an Internet connection.

Generally, carrier entities provide base pricing rates to shipper entities and to 3PL entities, where the 3PL entities typically mark up or increase the base pricing rates and sell to shipper entities at the increase amount. Conventionally, a carrier entity charges a price (“Price #1” and referred to herein as “base pricing rate”) that the carrier entity receives from a shipper or 3PL entity to transport freight, and incurs a cost (“Cost #1”) to transport the freight. Similarly, a 3PL entity pays a cost (“Cost #2”, which is the same as Price #1 or the base pricing rate) to a carrier entity to have freight transported, and charges a price (“Price #2”) to a shipper entity to have the freight transported. Further, a shipper entity pays a cost (“Cost #3”, which may be same as Price #1 (i.e., the base pricing rate) or Price #2) to a carrier entity or to a 3PL entity for the freight transport.

In some situations, a carrier entity may calculate a “dynamic pricing rate” using Cost #1 and/or Price #1 (i.e., the base pricing rate) along with at least one “dynamic pricing rule” and at least one “current condition.” Effectively, the dynamic pricing rate is the base pricing rate that is adjusted (i.e., increased or decreased) based on the dynamic pricing rule and/or the current condition. Accordingly, a 3PL entity pays a cost (i.e., the dynamic pricing rate) to the carrier entity to have freight transported, and charges a price (“Price #3”) to a shipper entity to have the freight transported. Additionally, a shipper entity pays a cost (which could be either the dynamic pricing rate or Price #3) to a carrier entity or to a 3PL entity for the freight transport. Shipper entities and carrier entities may communicate and retrieve price and cost information via respective sets of APIs, or using other connections or protocols. As understood herein, a “shipping agreement” may be any type of agreement or contract that is reached between a shipper entity and a carrier entity (and in some cases, a 3PL entity), where the carrier entity transports a set of products, goods, materials, and/or the like associated with the shipper entity, for an agreed-upon cost or price.

In some situations, a shipping agreement may be reached between a first shipper entity and a second shipper entity, or between a carrier entity and multiple shipper entities. For example, the second shipper entity may purchase a set of products, and the first shipper entity may contract with a 3PL entity to transport the set of products for delivery to the second shipper entity. Therefore, a shipping agreement need not be reached between a shipper entity and a carrier entity, but may alternatively be reached between a shipper entity and another shipper entity (or between a carrier entity and multiple shipper entities). It should also be understood that any party to a shipping agreement may interface with the agreement assessment module 110 and access data resulting therefrom; or, in some instances, one or more of the parties to a shipping agreement may be restricted from interfacing with the agreement assessment module 110 and accessing data resulting therefrom.

It should be appreciated that the components and entities of the system 100 may include and support various combinations of hardware and software components capable of facilitating various of the functionalities of the systems and methods. For example, the components and entities of the system 100 may generally support one or more computer processors, communication modules (e.g., transceivers), memories, and/or other components.

FIG. 1B an example environment 150 in which input data 117 is processed into output data 151 via an analysis platform 155, according to embodiments. The analysis platform 155 may be implemented on any computing device or combination of computing devices, including the server 109 as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156. In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The analysis platform 155 may further include a user interface 153 configured to present content (e.g., input data, output data, processing data, and/or other information). Additionally, a user may review results of a shipping agreement analysis and make selections to the presented content via the user interface 153, such as to review output data presented thereon, make selections, and/or perform other interactions. The user interface 153 may be embodied as part of a touchscreen configured to sense touch interactions and gestures by the user. Although not shown, other system components communicatively coupled to the system bus 158 may include input devices such as cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., an agreement analysis application 160) data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The analysis platform 155 may operate in a networked environment and communicate with one or more remote platforms, such as a remote platform 165, via a network(s) 162, such as a local area network (LAN), a wide area network (WAN), or other suitable network(s). The platform 165 may be implemented on any computing device, including any of the set of computing devices 115 as discussed with respect to FIG. 1A, and may include many or all of the elements described above with respect to the platform 155. In some embodiments, the agreement analysis application 160 as will be further described herein may be stored and executed by the remote platform 165 instead of by or in addition to the platform 155.

Generally, each of the input data 117 and the output data 151 may be embodied as any type of electronic document, file, template, etc., that may include various graphical/visual and/or textual content, and may be stored in memory as program data in a hard disk drive, magnetic disk and/or optical disk drive in the analysis platform 155 and/or the remote platform 165. The analysis platform 155 may support one or more techniques, algorithms, or the like for analyzing the input data 117 to generate the output data 151. In particular, the agreement analysis application 160 may analyze various types and forms of shipment and economic data and other parameters associated with a shipping agreement to calculate a likelihood of the shipping agreement being successfully fulfilled. Based on the analysis, the agreement analysis application 160 may output data (i.e., the output data 151) that indicates that calculated likelihood. Additionally, the agreement analysis application 160 may assess or determine how the status of the shipping agreement may change based on the calculated likelihood, where that information or data may also be embodied as the output data 151. The memory 157 may store the output data 151 and other data that the analysis platform 155 generates or uses in associated with the analysis of the input data 117.

According to embodiments, the agreement analysis application 160 may employ machine learning and artificial intelligence techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like. When the input data 117 is a training dataset, the agreement analysis application 160 may analyze/process the input data 117 to generate a machine learning model(s) for storage as part of model data 163 that may be stored in the memory 157.

When the input data 117 comprises various tracking, inventory, and/or economic data associated with a shipping agreement to be analyzed using the machine learning model, the agreement analysis application 160 may analyze or process the input data 117 using the machine learning model to generate the output data 151 that may comprise various information that indicates a likelihood that the shipping agreement will be successfully fulfilled. In embodiments, various of the output data 151 may be added to the machine learning model stored as part of the model data 163. In analyzing or processing the input data 117, the agreement analysis application 160 may use any of the output data 151 previously generated by the analysis platform 155.

The agreement analysis application 160 (or another component) may cause the output data 151 (and, in some cases, the training or input data 117) to be displayed on the user interface 153 for review by the user of the analysis platform 155. Additionally, the agreement analysis application 160 may analyze or examine the output data 151 to determine or assess status updates to shipping agreements, which may be displayed on the user interface 153 as part of a dashboard, interface, or the like. The user may select to review and/or modify the displayed data. For instance, the user may review the output data 151 to assess shipping updates, plan additional shipping agreements, and/or facilitate other functionalities.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 156 (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML, R, Stata, AI libraries). In some embodiments, the computer program product may be part of a cloud network of resources.

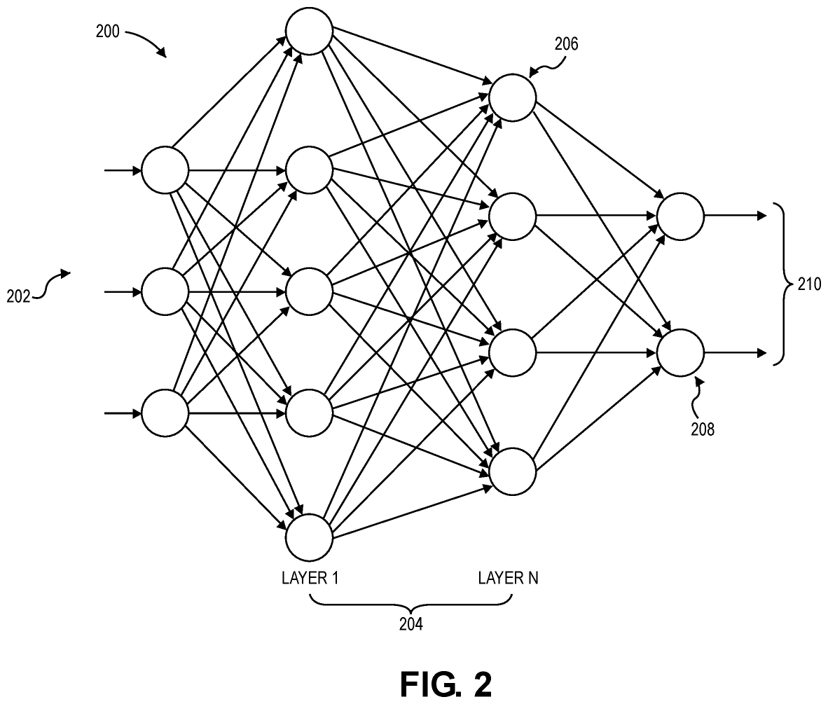

FIG. 2 depicts an exemplary deep learning artificial neural network (DNN) 200, which may be used in conjunction with the machine learning techniques as discussed herein. The DNN 200 may be trained and/or operated by the analysis platform 155 of FIG. 1B, for example. The DNN 200 may include a plurality of layers, each of which may include any number of respective neurons, or nodes.

The DNN 200 may include an input layer 202, one or more hidden layers 204, and an output layer 208. Each of the layers in the DNN may include an arbitrary number of neurons. The plurality of layers may chain neurons together linearly and may pass output from one neuron to the next, or may be networked together such that the neurons communicate input and output in a non-linear way. In general, it should be understood that many configurations and/or connections of DNNs are possible.

The input layer 302 may correspond to a large number of input parameters (e.g., one million inputs), in some embodiments, and may be analyzed serially or in parallel. Further, various neurons and/or neuron connections within the DNN may be initialized with any number of weights and/or other training parameters. Each of the neurons in the hidden layers 204 may analyze one or more of the input parameters from the input layer 202, and/or one or more outputs from a previous one or more of the hidden layers 204, to generate a decision 210 or other output. The output layer 208 may generate the decision 210 or more outputs, each indicating a prediction or an expected value. The number of input neurons may be stored as a predetermined value, and used to initialize a network for training.

In some embodiments and/or scenarios, the output layer 208 may include only a single output 210. For example, a neuron may correspond to one of the neurons in a hidden layer 206. Each of the inputs to the neuron may be weighted according to a set of weights W1 through Wi, determined during the training process (for example, if the neural network is a recurrent neural network) and then applied to a node that performs an operation α. The operation a may include computing a sum, a difference, a multiple, or a different operation. In some embodiments weights are not determined for some inputs. In some embodiments, neurons of weight below a threshold value may be discarded/ignored. The sum of the weighted inputs, r1, may be input to a function which may represent any suitable functional operation on r1. The output of the function may be provided to a number of neurons of a previous/subsequent layer or as an output 210 of the DNN. In some embodiments, the DNN may include one or more convolutional neural network (CNN) layers.

FIG. 3 depicts a signal diagram 300 with various functionalities associated with the described embodiments. The signal diagram 300 includes the following components: one or more data sources 320, a server 309, and a customer computing device 315. According to embodiments, the data source(s) 320 may be associated with one or more shipper entities, one or more carrier entities, one or more transportation management systems, and/or other data vendors. Further, the server 309 may be, for example, the server 109 as described with respect to FIG. 1A and may implement the analysis platform 155 as discussed with respect to FIG. 1B. Additionally, the customer computing device 315 may be, for example, the computing device 115 as discussed with respect to FIG. 1A and may be associated with a shipper entity. Generally, the shipper entity associated with the computing device 115 may reach a shipping agreement with a carrier entity to transport goods or products associated with an order.

Although the signal diagram 300 is described as employing artificial intelligence and machine learning to implement and facilitate various of the functionalities, it should be appreciated that the signal diagram 300 may operate without artificial intelligence or machine learning. In this regard, the signal diagram 300 may access inventory, tracking, and/or economic information from the data source(s) 320 and perform calculations on the information or data to determine relevant output data.

The signal diagram 300 may start with the server 309 training a machine learning model. In particular, the server 309 may access (322) a set of training data or a training dataset. Generally, the set of training data may include information indicating shipping agreements and the initiation, shipment, and delivery of the products specified thereby, and may be real-world data and/or simulated, labeled data. According to embodiments, the set of training data may include any combination of: order milestones, shipment statuses, inventory deviations, and economic trends.

Generally, a given shipping agreement for a set of goods, items, or products undergoes a set of milestones from agreement of the shipping agreement between a shipper entity and a carrier entity, to delivery of and payment for the shipping agreement, which may predict the shipping agreement's ability to be fulfilled throughout the lifecycle of the shipping agreement. Further, the shipping agreement has various associated dates, including an order submission date, a supplier ready date, and an original or intended due date. It should be appreciated that additional or alternative dates and milestones are envisioned. Further, it should be appreciated that a customer (e.g., a shipper entity) may specify or define certain dates or milestones.

Generally, a shipping agreement may be segmented into one or more shipments (i.e., a first shipment may be for a first subset of the product(s) in the shipping agreement, and a second shipment may be for a second subset of the product(s) in the shipping agreement). Therefore, a shipment may be a partial shipment or a full shipment. Further, a shipment may be intended to be a single leg shipment (i.e., directly from an origin to a destination), or a multi-leg shipment (i.e., from an origin to a destination via at least one intermediate stop). Additionally, a shipment may be single mode (i.e., transported from an origin to a destination using a single mode of transportation) or multimodal (i.e., transported from an origin to a destination using multiple modes of transportation).

According to embodiments, the shipment statuses may indicate, for each shipment associated with a given shipping agreement, whether that shipment is early, late, or on-time, and may additionally indicate an estimated time of arrive (ETA) for that shipment.

Further, the inventory deviations may reflect differences in expected or planned inventory levels and actual inventory levels, on a per-agreement basis. According to embodiments, the actual inventory levels may be received or determined either prior to the product(s) specified in a shipping agreement being in transit or while in transit, and may be provided by an involved supplier, carrier, or other party (e.g., 3PL).

Moreover, the economic trends may be derived from any information descriptive of the shipping industry, supply chains, economic indicators, and other aspects of portions or the entirety of national or global economies. For example, an economic trend may indicate an increase in consumer spending and ecommerce. Additionally or alternatively, the economic trends may indicate risks or obstacles with which the shipping industry (or another industry) may have to contend. For further example, an economic trend may indicate that a certain port has a backlog of ships, or that a canal is blocked, thus indicating that a shipment may not be delivered on time or that shipping costs may increase, among other possibilities. Generally, an entity associated with the server 309, or a shipper, carrier, or another entity, may collect data or information from various sources (e.g., the set of data sources 320) and predict or determine the economic trends, and may determine impacts to subsequent shipping jobs based on the determined economic trends.

The server 309 may train (324) the machine learning model using the set of training data. It should be appreciated that the server 309 may train the machine learning model using any combination of one or more techniques, calculations, or the like. The server 309 may store (326) the machine learning model, for example in the database 108 as discussed with respect to FIG. 1A or the memory 157 as discussed with respect to FIG. 1B.

Before, during, or after the server 309 trains the machine learning model, the customer computing device 315 may provide (328) data associated with a desired shipping agreement to the server 309. According to embodiments, the data may include information associated with the shipping agreement that a shipper would like performed, where the information may identify the goods or products to be shipped (including physical dimensions and/or a weight of the goods/products), a pickup location, a destination location, a desired pickup time, a desired delivery time, pricing, and/or other information.

The server 309 may accordingly book (329) or finalize the shipping agreement according to the shipping agreement information provided in (328). In particular, the server 309 may interface with a carrier entity that accepts the shipping agreement according to the shipping agreement information, where the carrier entity may be associated with or interface with one or more of the data source(s) 320. Accordingly, after the shipping agreement is booked or finalized, a shipping agreement may be deemed to have been reached, and the selected carrier entity may carry out or fulfill the shipping agreement according to the requested parameters and for the specified price/cost. Additionally, it may not be known which vehicle associated with the carrier entity is actually going to pick up, transport, and deliver the products, and it also may not be known how the products are being shipped (e.g., single or multi-leg, single or multimodal, partial of full shipments, etc.).

Before, during, and/or after the actual transporting of the products, the data source(s) 320 may provide (330) order/tracking/economic information associated with the shipping agreement to the server 309. In particular, the order/tracking/economic information may include any combination of the following: order milestones, shipment statuses, inventory deviations, and economic trends or risks.

In embodiments, the order milestones for the shipping agreement may be various associated dates, including an order submission date, a supplier ready date, and an original or intended due date. According to an implementation, various or all of the order milestones for the shipping agreement may be provided by the customer computing device 215 at (328).

Further, the shipment statuses may indicate (or the server 309 may derive from the information) whether the product(s) for the shipping agreement are divided into partial shipments, whether each shipment is a single or multi leg shipment, and whether each shipment is a single or multimodal shipment. For example, the shipping agreement may be divided into two partial shipments, the first shipment being a single leg shipment by truck, and the second shipment being a multi leg shipment initially completed by a ship and then by a truck.

According to embodiments, the shipment statuses may include real-time tracking data for vehicles that are transporting the products, such as from electronic logging devices or location modules integrated within the vehicles. Thus, the server 309 may derive, from the shipment statuses and for each shipment associated with a given shipping agreement, whether the shipment is early, late, or on-time, as well as an estimated time of arrive (ETA) for that shipment. Additionally, the server 309 may determine point-to-point average lead times for each shipment which the server 309 may use to determine the expected transmit time for that shipment.

Further, the inventory deviations may reflect differences in expected or planned inventory levels and actual inventory levels. According to embodiments, the planned inventory levels may be included in the data received in (328), and the actual inventory levels may be included in the data received in (330) and supplied by an involved supplier, carrier, or other party (e.g., 3PL) either pre-transit or while the shipment is in transit. According to embodiments, the data received in (330) may indicate an inventory of the products being transported by a given vehicle.

The server 309 may compare the planned inventory levels to the actual inventory levels to determine any deviations, discrepancies, and/or the like. For example, the planned inventory level may indicate that a shipping agreement is to be completed by five (5) trucks, while the actual inventory level may indicate that only four (4) trucks are transporting the products associated with the shipping agreement; accordingly, the server 309 may determine that the shipment is missing inventory equal up a capacity of a truck. For further example, the planned inventory level for a shipping agreement is one hundred (100) washing machines, while the actual inventory level may indicate that only ninety (90) washing machines are being transported by a set of vehicles; accordingly, the server 309 may determine that there is a deficiency of ten (10) washing machines.

According to embodiments, the order/tracking information provided in (330) may indicate one or more economic trends and/or risks descriptive of the current state of the shipping industry, supply chains, economic indicators, weather conditions, and other aspects of portions or the entirety of regional, national, or global economies. For example, a trend may indicate that a specific national economy is experiencing higher-than-normal sales volume for a particular product. For further example, that data may indicate that there is backlog of containers at a specific port in a specific country. Generally, the server 309 may review the order/tracking/economic information provided in (330) to determine any potentially impacts to the shipping agreement.

The server 309 may analyze (332) the information provided in (328) and (330) using the machine learning model. In particular, the server 309 may input, into the machine learning model, at least a portion of the information provided in (330), which may include any combination of order milestones, shipment statuses, inventory deviations, and economic trends or risks, and at least a portion of the information provided in (328), which may include any combination of an identification of goods or products to be shipped (including physical dimensions and/or a weight of the goods/products), a pickup location, a destination location, a desired pickup time, a desired delivery time, pricing, and/or other information.

Generally, the analysis of the machine learning model may calculate or determine a probability or likelihood of the shipping agreement being successfully fulfilled. According to embodiments, a shipping agreement may be deemed to be successfully fulfilled if all of the goods or products (or a threshold percentage of the goods or products (e.g., 98%)) are delivered to the desired destination by the desired delivery time or date (or within a threshold time or date of the desired delivery time or date (e.g., within 1 day)).

It should be appreciated that any thresholds may be default values or specified by a user or administrator (e.g., an individual associated with a shipper entity. For example, a given shipping agreement may be deemed as successfully fulfilled if at least 99% of the specified products are delivered to the desired destination within two days of the desired delivery date. In this example, the machine learning model may output a probably of 85% that at least 99% of the specified products will be delivered to the desired destination within two days of desired delivery date. It should be appreciated that the server 309 may perform the machine learning model analysis on a continuous basis as additional data (e.g., the data received in (330)) is provided.

The server 309 may avail (332) the output from the machine learning model. According to embodiments, the server 309 may update a status of the shipping agreement based on the output, and may update an associated dashboard, account, interface, or the like. For example, if the output indicates that the product order has less than a threshold percentage of being successfully fulfilled (e.g., 70%), then a dashboard may “flag” that product order for review or follow up by a user. Similarly, a dashboard may be divided into different sections, each one having a different probability range. For example, a “red” section may include shipping agreements with less than a 50% chance of successful delivery, a “yellow” section may include shipping agreements with a 50%-80% chance of successful delivery, and a “green” section may include shipping agreements with greater than 80% chance of successful delivery.

In this regard, users may review the dashboard to assess which shipping agreements may need to be followed up on or need some type of manual, automatic, or dynamic intervention. For example, if a given shipping agreement has a less than 50% chance of successful delivery, the server 309 may automatically generate and send an electronic communication (e.g., email or text message) to an appropriate entity that indicates details associated with the shipping agreement and identifies any issues associated with the fulfilment and potential interventions or ways to address the issues. It should be appreciated that the thresholds, dashboard information, communication content and transmission, and other information and functionalities are automatically defined or configurable by a user.

It should be appreciated that the server 309 may be configured to generate any type of notification, electronic message (e.g., email), or the like in association with processing the output from the machine learning model. Additionally, the server 309 may transmit or communicate the notification or message via any type of electronic delivery medium, network, or the like. Further, the notification or message may include various graphical or textual content for the associated user to review.

The server 309 may update (336) the machine learning model based on the analysis of the data and output resulting therefrom. In this regard, the machine learning model may be continuously updated as new data is received and analyzed.

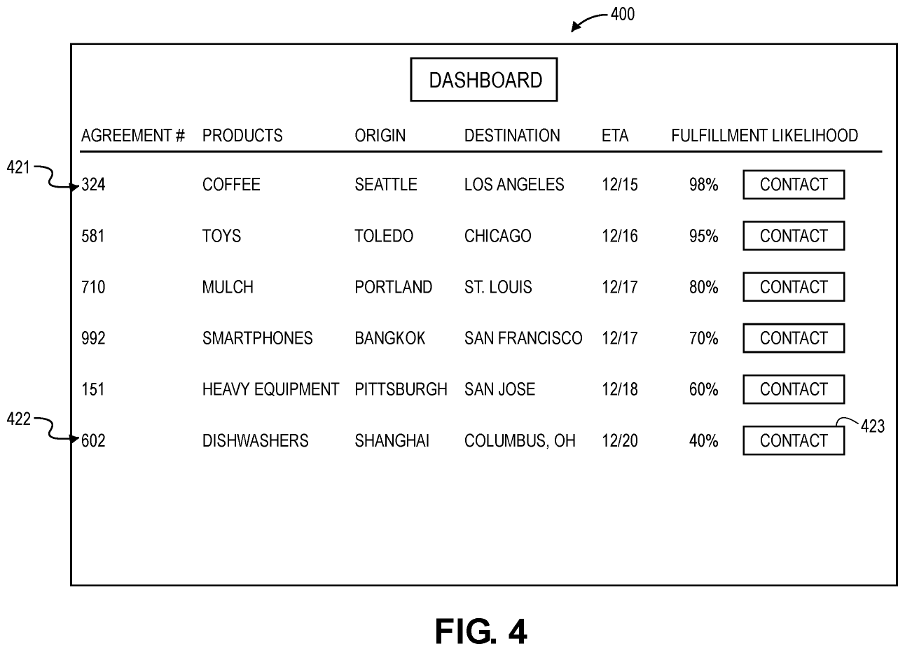

FIG. 4 is an example interface 400 associated with an example shipper entity. According to embodiments, a user associated with the shipper entity may use a computing device to review the interface 400 and assess various actions to undertake. Additionally, a server (e.g., the server 109) may generate or determine the information included in the interface 400, as discussed herein. It should be appreciated that the interface 400 is merely an example, and that additional or alternative information is envisioned such as, for example, carrier identification, vehicle(s) identification, current location(s) of the vehicle(s), and/or other information.

Generally, the interface 400 may indicate current shipping agreements that the shipper entity has with various carrier entities. As illustrated in FIG. 4, the interface 400 may include, for each shipping agreement, the following information: agreement number, products being transported, origin location, destination location, estimated time of arrival, and fulfillment likelihood. It should be appreciated that alternative and additional information is envisioned. According to embodiments, a machine learning model may determine the fulfillment likelihood based on the analyses techniques as discussed herein, and a server may generate the interface 400 and information included therein.

The user may review the interface 400 to ascertain the fulfillment likelihoods for the shipping agreements. For example, row 421 indicates that that agreement #324 of coffee from Seattle to Los Angeles has a 98% likelihood of being successfully fulfilled. Additionally, for example, row 422 indicates that agreement #602 of dishwashers from Shanghai to Columbus, OH has a 40% likelihood of being successfully fulfilled.

The interface 400 may further include a set of selections to contact or communicate with relevant entities associated with the shipping agreements. For example, the interface 400 may include a contact selection 423 that the user may select. According to embodiments, in response to the user selecting the selection 423, the server may identify any entities associated with the shipping agreement (e.g., a carrier entity), and automatically generate and transmit a set of electronic communications to any identified entities. In some embodiments, the interface 400 may display a set of contact information associated with any identified entities in response to the user selecting the selection 423. Thus, the server (and/or the user) may initiate various actions in an attempt to determine and address potential issues associated with one or more shipments of the shipping agreement so that the likelihood of fulfillment is improved.

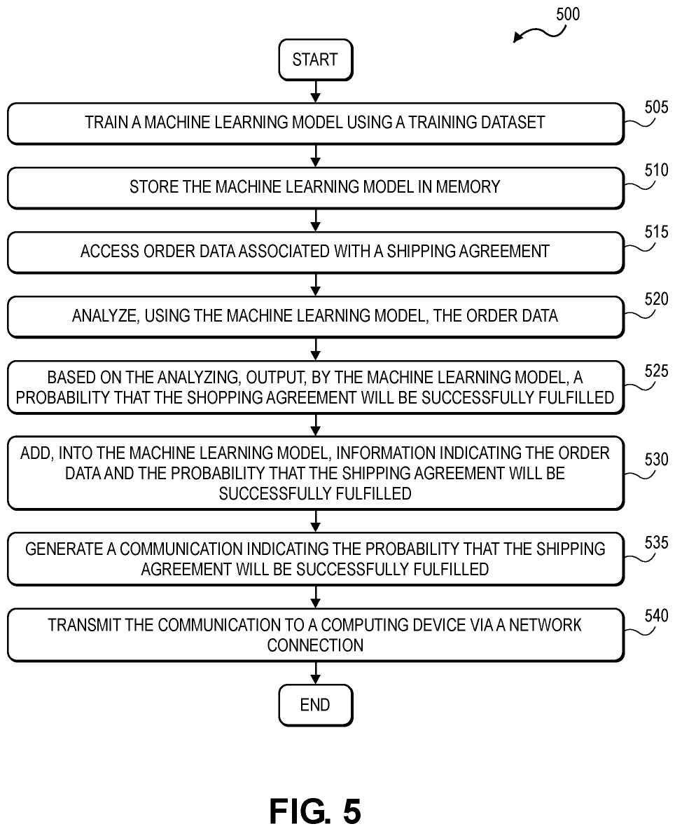

FIG. 5 depicts is a block diagram of an example method 500 of using machine learning to predict order fulfillment. The method 500 may be facilitated by an electronic device (such as the server 109 as depicted in FIG. 1A). In embodiments, the electronic device may communicate with a set of data sources and a set of computing devices. As discussed herein, it should be appreciated that the electronic device may execute or facilitate the method 500 without training or using a machine learning model, and instead access/receive data and analyze the data to generate output data.

The method 500 may begin when the electronic device trains (block 505) a machine learning model using a training dataset. According to embodiments, the training dataset may include a training set of order milestones, a training set of shipment statuses, a training set of inventory deviations, and/or a training set of economic trends. Further, the electronic device may store (block 510) the machine learning model in memory.

The electronic device may access (block 515) order data associated with a shipping agreement. According to embodiments, the order data may include a set of order milestones for the shipping agreement, a set of shipment statuses for the shipping agreement, a set of inventory deviations for the shipping agreement, and/or a set of economic trends. Generally, the shipping agreement may be an order or a shipment for a set of products to be transported by a set of vehicles associated with a carrier entity. Further, the electronic device may receive, from a computing device(s) via a network connection(s), the order data from various sources including devices associated with warehouses or ports, an electronic logging device(s) associated with a set of vehicles, and/or other sources.

The electronic device may analyze (block 520), using the machine learning model, the order data. Generally, the analysis of the machine learning model may be used to assess how the shipping agreement is proceeding when compared to the parameters for the order (e.g., the amount of products/items as specified in the order).

The electronic device may, based on the analyzing, output (block 525), by the machine learning model, a probability that the shipping agreement will be successfully fulfilled. According to embodiments, the probability may be a numeric indicator on a defined scale (e.g., a percentage from 0-100% or an integer from 1-10, etc.). Generally, a shipping agreement may be considered successfully fulfilled if all of the products (or a set threshold percentage of products (e.g., 98%)) specified in the shipping agreement are delivered to the desired destination. In embodiments, successful fulfillment may additionally be considered to happen if the all of the products are delivered on time (or within a threshold number of days of an originally-estimated delivery date (e.g., two days)).

The electronic device may add (block 530), into the machine learning model, information indicating the order data and the probability that the shipping agreement will be successfully fulfilled. As a result, the machine learning model may be consistently updated with the results of its analyses.

The electronic device may generate (block 535) a communication indicating the probability that the shipping agreement will be successfully fulfilled. According to embodiments, the communication may include other aspects associated with the shipping agreement, and may be combined with other shipping agreements associated with a shipper entity. The electronic device may transmit (block 540) the communication to a computing device via a network connection. According to embodiments, the computing device may be associated with a shipper entity associated with the shipping agreement, or another entity.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A computer-implemented method of training and using deep learning artificial neural networks, the method comprising:
training, by one or more computer processors, a deep learning artificial neural network using a training dataset comprising: (i) a training set of order milestones, (ii) a training set of shipment statuses, and (iii) a training set of differences between planned shipment amounts and actual shipment amounts;
storing the deep learning artificial neural network in a memory;
receiving shipping data associated with a set of vehicles transporting products associated with a shipping agreement;
on a continuous basis as the shipping data is received, analyzing, by the one or more computer processors using the deep learning artificial neural network that was trained, the shipping data and order data associated with the shipping agreement, the order data indicating (i) whether the shipping agreement is divided into partial shipments, and (ii) an amount of products planned to be transported, and the shipping data indicating an amount of products actually being transported;
based on the analyzing, outputting, by the deep learning artificial neural network, a probability that the shipping agreement will be successfully fulfilled, wherein the probability is less than a threshold percentage; and
updating, by the one or more computer processors, the deep learning artificial neural network with information indicating the order data associated with the shipping agreement and the probability that the shipping agreement will be successfully fulfilled.

2. The computer-implemented method of claim 1, wherein training the deep learning artificial neural network comprises:
training, by the one or more computer processors, the deep learning artificial neural network using the training dataset comprising: (i) the training set of order milestones, (ii) the training set of shipment statuses, (iii) the training set of differences between planned shipment amounts and actual shipment amounts, and (iv) a training set of economic trends.

3. The computer-implemented method of claim 1, further comprising:
generating, by the one or more processors, a communication indicating the probability that the shipping agreement will be successfully fulfilled; and
transmitting the communication to a computing device via a network connection.

4. The computer-implemented method of claim 3, wherein the computing device is associated with a shipper entity, and wherein transmitting the communication comprises:
updating, by the one or more processors, the communication to reflect at least one additional shipping agreement associated with the shipper entity; and
transmitting the communication that was updated to the computing device via the network connection.

5. The computer-implemented method of claim 1, wherein each of the training set of order milestones, the training set of shipment statuses, and the training set of differences between planned shipment amounts and actual shipment amounts comprises simulated and labeled data.

6. The computer-implemented method of claim 1, further comprising:
accessing, by the one or more processors, (i) a first portion of the order data from a set of parameters associated with the shipping agreement, and (ii) a second portion of the order data from a set of data sources while the amount of products specified by the shipping agreement is in transit.

7. The computer-implemented method of claim 1, further comprising:
updating, by the one or more computer processors, a status of the shipping agreement based on the probability that the shipping agreement will be successfully fulfilled; and
updating, by the one or more computer processors, a dashboard to reflect the status of the shipping agreement that was updated.

8. The computer-implemented method of claim 7, wherein the dashboard is divided into different sections each of which has a designated probability range, and wherein updating the dashboard to reflect the status of the shipping agreement that was updated comprises:
updating, by the one or more computer processors, the dashboard to indicate the shipping agreement in an appropriate section of the different sections according to the probability that the shipping agreement will be successfully fulfilled.

9. A system for training and using deep learning artificial neural networks, comprising:
a memory storing a set of computer-readable instructions and data associated with a deep learning artificial neural network; and
one or more processors interfaced with the memory, and configured to execute the set of computer-readable instructions to cause the one or more processors to:
train a deep learning artificial neural network using a training dataset comprising: (i) a training set of order milestones, (ii) a training set of shipment statuses, and (iii) a training set of differences between planned shipment amounts and actual shipment amounts,
store the deep learning artificial neural network in a memory,
receive shipping data associated with a set of vehicles transporting products associated with a shipping agreement,
on a continuous basis as the shipping data is received, analyze, using the deep learning artificial neural network that was trained, the shipping data and order data associated with the shipping agreement, the order data indicating (i) whether the shipping agreement is divided into partial shipments, and (ii) an amount of products planned to be transported, and the shipping data indicating an amount of products actually being transported,
based on the analyzing, output, by the deep learning artificial neural network, a probability that the shipping agreement will be successfully fulfilled, wherein the probability is less than a threshold percentage, and
update the deep learning artificial neural network with information indicating the order data associated with the shipping agreement and the probability that the shipping agreement will be successfully fulfilled.

10. The system of claim 9, wherein to train the deep learning artificial neural network, the one or more processors is configured to:
train the deep learning artificial neural network using the training dataset comprising: (i) the training set of order milestones, (ii) the training set of shipment statuses, (iii) the training set of differences between planned shipment amounts and actual shipment amounts, and (iv) a training set of economic trends.

11. The system of claim 9, wherein the one or more processors is configured to execute the set of computer-readable instructions to further cause the one or more processors to:
generate a communication indicating the probability that the shipping agreement will be successfully fulfilled, and
transmit the communication to a computing device via a network connection.

12. The system of claim 11, wherein the computing device is associated with a shipper entity, and wherein to transmit the communication, the one or more processors is configured to:
update the communication to reflect at least one additional shipping agreement associated with the shipper entity, and
transmit the communication that was updated to the computing device via the network connection.

13. The system of claim 9, wherein each of the training set of order milestones, the training set of shipment statuses, and the training set of differences between planned shipment amounts and actual shipment amounts comprises simulated and labeled data.

14. The system of claim 9, wherein the one or more processors is configured to execute the set of computer-readable instructions to further cause the one or more processors to:
access (i) a first portion of the order data from a set of parameters associated with the shipping agreement, and (ii) a second portion of the order data from a set of data sources while the amount of products specified by the shipping agreement is in transit.

15. The system of claim 9, wherein the one or more processors is configured to execute the set of computer-readable instructions to further cause the one or more processors to:
update a status of the shipping agreement based on the probability that the shipping agreement will be successfully fulfilled, and
update a dashboard to reflect the status of the shipping agreement that was updated.

16. The system of claim 15, wherein the dashboard is divided into different sections each of which has a designated probability range, and wherein to update the dashboard to reflect the status of the shipping agreement that was updated, the one or more processors is configured to:
update the dashboard to indicate the shipping agreement in an appropriate section of the different sections according to the probability that the shipping agreement will be successfully fulfilled.

17. A non-transitory computer-readable storage medium configured to store instructions executable by a computer processor, the instructions comprising:
instructions for training a deep learning artificial neural network using a training dataset comprising: (i) a training set of order milestones, (ii) a training set of shipment statuses, and (iii) a training set of differences between planned shipment amounts and actual shipment amounts;
instructions for storing the deep learning artificial neural network in a memory;
instructions for receiving shipping data associated with a set of vehicles transporting products associated with a shipping agreement;
instructions for, on a continuous basis as the shipping data is received, analyzing, using the deep learning artificial neural network that was trained, the shipping data and order data associated with the shipping agreement, the order data indicating (i) whether the shipping agreement is divided into partial shipments, and (ii) an amount of products planned to be transported, and the shipping data indicating an amount of products actually being transported;
instructions for, based on the analyzing, outputting, by the deep learning artificial neural network, a probability that the shipping agreement will be successfully fulfilled, wherein the probability is less than a threshold percentage; and
instructions for updating the deep learning artificial neural network with information indicating the order data associated with the shipping agreement and the probability that the shipping agreement will be successfully fulfilled.

18. The non-transitory computer-readable storage medium of claim 17, wherein the instructions for training the deep learning artificial neural network comprise:
instructions for training the deep learning artificial neural network using the training dataset comprising: (i) the training set of order milestones, (ii) the training set of shipment statuses, (iii) the training set of differences between planned shipment amounts and actual shipment amounts, and (iv) a training set of economic trends.

19. The non-transitory computer-readable storage medium of claim 17, wherein each of the training set of order milestones, the training set of shipment statuses, and the training set of differences between planned shipment amounts and actual shipment amounts comprises simulated and labeled data.

20. The non-transitory computer-readable storage medium of claim 17, wherein the instructions further comprise:
instructions for updating a status of the shipping agreement based on the probability that the shipping agreement will be successfully fulfilled; and
instructions for updating a dashboard to reflect the status of the shipping agreement that was updated.
